(19) United States
(12) Patent Application Publication
(10) Pub. No.: US 2009/0196051 A1
(43) Pub. Date: Aug. 6, 2009

(54) Universal form fitting removable lampshade cove

(75) Inventors: Shelly D. Dick, Baton Rouge, LA (US); Wanda B. Guadamud, Baton Rouge, LA (US)

Correspondence Address: Richard J. Hammond, 5218 Riverbend Blvd., Baton Rouge, LA, 70820, US

(73) Assignee: Lamp Ladies LLC; d/b/a FROCKZ

(21) Appl. No.: 12/321,680

(22) Filed: Jan. 23, 2009

Related U.S. Application Data
(60) Provisional application No. 61/024,979, filed on Jan. 31, 2008.

(51) Int. Cl. F21V 1/14

(52) U.S. Cl. 362/351; 362/357

(57) ABSTRACT

A cover for existing lampshades is disclosed. The cover has a single seam, is form fitting, conforms to the size and shape of an existing lampshade, is easy to install, requires no permanent fixatives or adhesive to hold in place and is removable, washable and reusable. The lampshade cover is made from at least one band of four way stretch fabric seamed together at one side thereby forming a top and a bottom opening. The top and bottom opening are circumscribed by an elastic band sewn onto the four way stretch fabric. This forms a finished edge on the top and on the bottom opening. The result is a one size fits many, form-fitting, removable, washable, reusable cover for existing lampshades.

### RELATED APPLICATIONS

The present application is related to U.S. Provisional Application No. 61\024,979, filed Jan. 30, 2008, entitled “UNIVERSAL, FORM-FITTING, and REMOVABLE LAMPSHADE COVER” and claims the benefit of the filing date of said Provisional Patent Application.

### FIELD OF INVENTION

The present invention relates generally to lighting and furnishings accessories. More particularly the present invention relates to lampshades and covers for lampshades.

### BACKGROUND OF THE INVENTION

Lampshades are typically manufactured from relatively stiff material, generally a styrene or paper composite, and sometimes a fabric, that is secured to a rigid metal frame. The functional purpose of a lamp shade is to diffuse the glare and brightness of the light source, typically an incandescent, halogen or fluorescent bulb. Lampshades can also serve as a decorative element in a room's interior design. However, most lampshades are supplied in a neutral color in order to coordinates with a variety of interior decors. Decorative lampshades can be expensive and the availability of design choices is limited. Custom made lamp shades, covered with an individual's choice of fabric or design, are extremely expensive and therefore economically out of reach of the average consumer.

The useful life of a lampshade is significantly shorter than the useful life of the lamp or light fixture itself. Lampshade replacement is required or desirable for principally two reasons. Either the lampshade is worn, deteriorated or damaged or replacement is desirable for decorative reasons. Unfortunately, lampshade replacement is both costly and difficult. Lampshade replacement is difficult because a replacement shade of the precise size and shape may not be readily available.

Because of design limitations inherent in lampshades, and the difficulty and expense of replacing worn or used lampshades, it is desirable to provide a means and method of covering existing lampshades. A single lampshade cover that can be retrofitted to fit a number (more than one) of existing lampshades of various shapes and sizes and which is form fitting and conforms to various sizes and shapes of the existing shade represents a utilitarian improvement to the known prior art in the area of lampshade covers. A one size fits many, form fitting lampshade cover enables continued use of a variety of lamps and lampshades and maintains the appearance of the original lamp and shade design while updating the appearance and/or camouflaging wear and tear of the underlying shade.

The present invention provides an improved lampshade cover and method for covering a lampshade. Such improved lampshade cover is of the one size fits many type. It is a single size but provides a form fitted cover for a wide array of different lamp shade sizes and shapes.

As a further embodiment, the present invention provides an improved method for covering an existing lampshade because of the one size fits many feature and because the material and configuration provides a form fitted and conforming cover that can be used on a multitude of differently sized and shaped lampshades.

The lampshade cover of the present invention can be produced in a wide variety of colors, prints, patterns and textures. The lampshade cover of the present invention can be easily attached and removed without damage to the lampshade. The lampshade cover of the present invention is washable and re-usable and, after washing, retains its universal fit qualities.

Significant and important features of the lampshade cover of the present invention are: its universality in fit and the adaptability of a single size and configuration in order to conform and form fit to the size shape and profile of a multitude of different sized and shaped lampshades; the non-destructive characteristic with respect to the lampshade being covered; its wash ability and reusability; and the social utility of encouraging and promoting the re-use and recycling of lampshades already in commerce.

Covers for lampshades are well known. However, there are a number of problems associated with employing a cover over an existing lampshade. The problems associated with attempting to cover a presently existing lampshade include: the lack of universal sizing of the cover, i.e., lampshade covers have been limited in their functionality by their inability to fit the variety of different sized and shaped shades presently in use; the covers are often ill fitting insofar as they do not conform to or form fit the multitudinous variety of lampshade sizes and shapes presently in commerce; the covers frequently require tucks, puckers, pleats draw strings and/or multiple seams in order to adapt to the variety of sizes and shapes of lampshades; the method and manner of attachment of the cover, e.g., using draw string casings and Velcro, results in an undesirable aesthetic appearance; and the covers typically overhang from the top and from the bottom openings of the lampshade being covered.

Accordingly, there is a need for an improved covering for lampshades and method for accomplishing such covering.

The subject invention provides an improved method for covering a vast array and variety of existing lampshades. The subject invention provides an improved lampshade cover and method because it is capable of being used with an existing lamp and lampshade, regardless of the form, shape and size of the lampshade. A single size of the improved lampshade cover will provide a form fit and conform to the contours of a number of different shapes and sizes of lamp shades, thus providing a universality and uniformity of fit. The improved lampshade provides a form fit and conforms to more than one shape, size and form of lampshade without bumps, lumps, pleats, puckers, gathers etc. The improved lampshade cover provides a finished edge and appearance at the point that the cover meets the top opening of the shade and also at the point that the cover meets the bottom opening of the shade. The improved lampshade cover and method is easily attached to and removed from an existing lampshade without the use of adhesives or permanently attached clips or fasteners and without damaging the lampshade. The improved lampshade and method is easily removable and machine washable and thereafter re-installable and re-usable. After washing, the improved lampshade cover retains its qualities of providing a universal form fit to a variety of shaped and sized lampshades. The improved lampshade cover and method is capable of being provided in fabric available in a variety of colors, patterns, prints and textures.

### SUMMARY OF THE INVENTION

It is an object of the present invention to provide an improved method for covering a variety of different shaped and sized lampshades. The present invention relates to a single sided or reversible cover for a lampshade that has:

a single seam;

is form fitting;

conforms to the size and shape of an existing lampshade;

is easy to install;

requires no permanent fixatives or adhesive to hold in place; and

is removable, washable and reusable.

A single size and configuration of the present invention lampshade cover provides a conforming fit to a variety of different sized and shaped lampshades, i.e., it will conform to and will form fit a wide number and variety of different shapes and sizes of lampshades.

The cover may be single sided or the cover may have a first color, pattern or design printed on the first side and a second color, pattern or printed on the second side making the cover reversible.

It is a further object of this invention to provide an improved one size fits many lampshade cover in which a single size will provide a form fit to a wide array of different shaped and sized lampshades.

It is an additional object of this invention to provide a lampshade cover that is easily installed, removable, washable and reusable all without damage to the existing or underlying lampshade.

It is the further object of this invention to provide a lampshade cover that presents an aesthetically pleasing, finished top and bottom opening, where the top and bottom openings of the lampshade cover conform to the top and bottom opening of the shade.

It is the further object of this invention to provide a lampshade cover that is available in a vast array of colors, patterns, prints and textures.

### DESCRIPTION OF DRAWINGS

The features, objects and usefulness of the present invention will be more clearly understood from a consideration of the accompanying drawings which illustrate the following:

FIG. 1 is an elevational view of a rectangular shaped piece cut from a washable, four way stretch fabric used to construct the drum shaped lampshade cover embodiment of the present invention.

FIG. 2 is a perspective view of the lampshade covering of the present invention wherein the shape of the covering is drum shaped and the sides 1 and 2 in FIG. 1 are joined together.

FIG. 3 is an elevational view of an arc shaped piece cut from a washable, four way stretch fabric used to construct a cone shaped lampshade covering embodiment.

FIG. 4 is a perspective view of the lampshade covering of the present invention wherein the shape of the covering is cone shaped and sides 3 and 4 of FIG. 3 are joined together.

FIG. 5 is a perspective view of a drum shaped lampshade covering of the present invention moving in a downward direction toward a lampshade which is to be covered by said lampshade covering.

FIG. 6 is a perspective view of a drum shaped lampshade covering of the present invention moving in a downward direction toward a lampshade of different configuration than shown in FIG. 5 which is to be covered by said lampshade covering.

FIG. 7 is a perspective view of a drum shaped lampshade covering of the present invention moving in a downward direction toward a lampshade of different configuration than shown in FIG. 5 which is to be covered by said lampshade covering.

FIG. 8 is a perspective view of a cone shaped lampshade covering of the present invention moving in a downward direction toward a lampshade which is to be covered by said lampshade covering.

FIG. 9 is a perspective view of a cone shaped lampshade covering of the present invention moving in a downward direction toward a lampshade of different configuration than shown in FIG. 8 which is to be covered by said lampshade covering.

FIG. 10 is a perspective view of a cone shaped lampshade covering of the present invention moving in a downward direction toward a lampshade of different configuration than shown in FIG. 8 which is to be covered by said lampshade covering.

### DETAILED DESCRIPTION OF INVENTION

Referring to FIG. 2, a drum shaped lampshade cover is shown. Referring to FIG. 4 a cone shaped lampshade cover is shown.

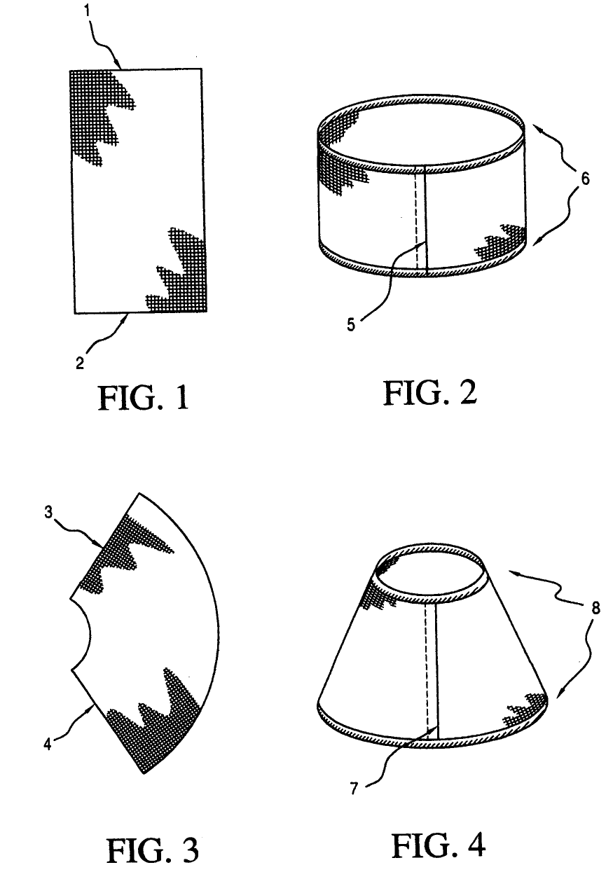

A preferred embodiment of the present invention is a lampshade cover comprised of at least one rectangular band of washable, four way stretchable fabric as shown in FIG. 1. Referring to FIG. 1 and FIG. 2, a lampshade cover is constructed by joining left edge 1 with right edge 2, which is distant from the left edge, of the rectangular shaped, washable four way stretch fabric (FIG. 1). Such joining forms a cylindrical or drum shaped cover having a single seam 5 (FIG. 2). The fabric forming the top and the bottom opening of the cylindrical or drum shaped lampshade cover are circumscribed by an elastic band attached, typically by sewing, by adhesives, etc. on to both the top and bottom openings. If attached by sewing, a stretch stitch or a serge stitch may be used. A finished edge on the four way stretch fabric forming the top and bottom opening 6 of the cylindrical or drum shaped shade cover is thereby formed.

A further preferred embodiment of the present invention is a lampshade cover comprised of at least one arc shaped band of washable four way stretchable fabric as shown in FIG. 3. Referring to FIG. 3 and FIG. 4, a lampshade cover is constructed by joining left edge 3 to right edge 4, which is distant from said left edge, of the arc shaped washable four way stretch fabric (FIG. 3). Such joining forms a cone shaped cover having a single seam 6 (FIG. 4). The fabric forming the top and the bottom opening of the cone shaped lampshade cover are circumscribed by an elastic band attached to the fabric forming the top and the bottom openings, typically by using an adhesive or a stretch stitch or serge stitch. A finished edge on the top and the bottom openings of the cone shaped shade cover is formed.

The elastic band on the fabric of the top and bottom openings of the cover on the present invention allows the cover to be securely placed over and attached to the underlying lampshade and, by stretching, is readily released and removed from it.

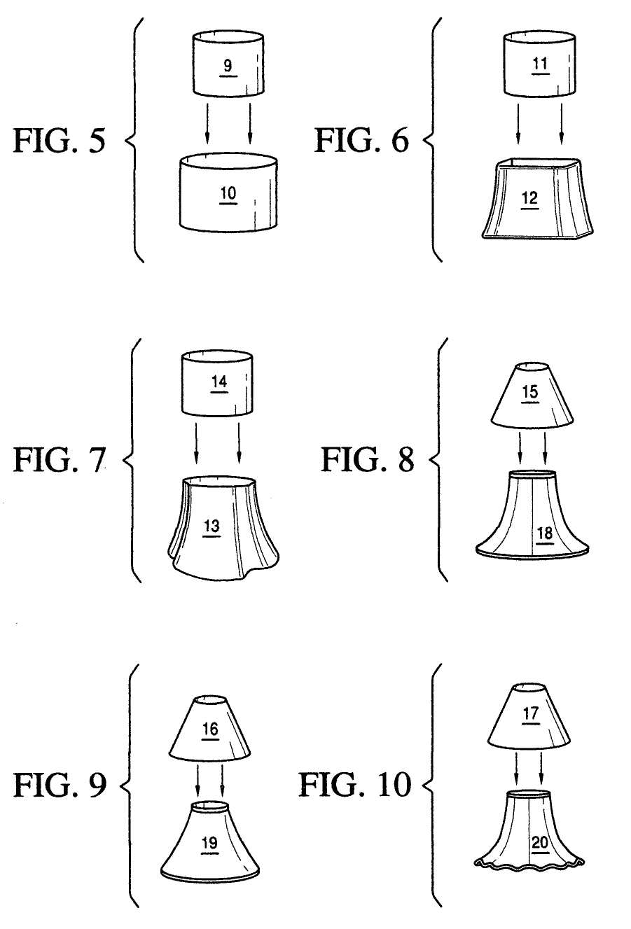

The cylindrical or drum shaped lampshade cover shown in FIG. 2, functions as a sleeve or cover for a lampshade of virtually any shape where the top and bottom openings of the lampshade are approximately the same dimension or circumference, including, but not limited to cylindrical lampshades shown in FIG. 5, at 10, rectangular lampshades shown in FIG. 6, at 12 and empire-style lampshades shown in FIG. 7, at 13 as well as square lamp shades, not shown.

The cone shaped lampshade cover shown in FIG. 4, functions as a sleeve or cover for a lampshade of virtually any shape where the top opening of the lampshade cover is about ½ the dimension or circumference of the bottom opening of the lampshade including, but not limited to bell shaped lampshades shown in FIG. 8, at 18, cone shaped lampshades shown in FIG. 9, at 19 and tulip-style lampshades shown in FIG. 10, at 20.

The use of four way stretch fabric and elastic bands in the construction of lampshade covers of the present invention enable the shade cover to form fit lampshades with dimensions that are the same size as the cover or larger, thus a single size of the present invention will stretch and conform to fit and cover a range of lampshade sizes equal to or larger than the size of the lampshade cover.

Advantages of the present invention include promoting recycling and reuse of existing shades by enabling consumers to refurbish and reclaim the usefulness of existing shades by covering and thereby hiding dirt, stains wear and tear. As such, the present invention transforms a worn or tattered shade into a useful and decorative shade. Additionally, the lampshade cover of the present invention: eliminates the need to embark on the time consuming and expensive task of shade replacement; is washable, thus reducing and/or eliminating allergens, dust, dirt and grime that typically accumulate on lampshades; is removable, enabling consumers to redecorate easily without changing or replacing lampshades; and can be used to cover and protect expensive silk or linen shades or delicate paper shades.

The lampshade cover of the present invention should be construed to encompass all variations, modifications, permutations, adaptations or additions that would occur to one skilled in this art who has been taught the present invention by the instant patent application.

Having described this invention, it should be apparent that numerous structural modifications and adaptations may be resorted to without departing from the scope and fair meaning of the instant invention as set forth herein.

We claim:

1. A one size fits many, form-fitting, removable, washable, reusable cover for existing lampshades comprising a variety of shapes and sizes, said cover comprising, in combination, at least one band of four way stretch fabric seamed together at one side thereby forming a top and a bottom opening of said cover, said four way stretch fabric of the top and bottom opening of said cover circumscribed by an elastic band sewn onto the four way stretch fabric to form a finished edge on said top and on said bottom opening of said cover wherein a one size fits many, form-fitting, removable, washable, reusable cover for existing lampshades is formed.

2. The one size fits many, form-fitting, removable, washable, reusable cover for existing lampshades comprising a variety of shapes and sizes in accordance with claim 1, wherein said band of four way stretch fabric is rectangular in shape and said top and said bottom opening have substantially the same or approximately the same circumference.

3. The one size fits many, form-fitting, removable, washable, reusable cover for existing lampshades comprising a variety of shapes and sizes in accordance with claim 1, wherein said band of four way stretch fabric is arc shaped and said top opening has a circumference smaller in circumference than that of said bottom opening.

4. The form-fitting, removable, washable, reusable cover for existing lampshades comprising a variety of shapes and sizes in accordance with claim 1, wherein the band of four way stretch fabric is solid, textured, printed, embellished, monogrammed, or bears designs or logos.

5. The form-fitting, removable, washable, reusable cover for existing lampshades comprising a variety of shapes and sizes in accordance with claim 1 wherein said band of four way stretch fabric is comprised of a first band having a first color pattern or design printed on said band and a second band having a second color pattern or design printed on said band, said first band and said second band being identically sized and shaped and sandwiched together thereby providing a first color, pattern or design printed on the first band that is the same or different from the second color, pattern or design printed on the second band.

6. The form-fitting, removable, washable, reusable cover for existing lampshades comprising a variety of shapes and sizes in accordance with claim 5 wherein the cover is reversible.

7. A method for covering an existing lampshade with a one size fits many, form-fitting, removable, washable, reusable cover said method comprising providing at least one band of four way stretch fabric having a left edge and a right edge distant from said left edge, joining together said left edge and said right edge of said at least one band of four way stretch fabric to form a cover that is conical or cylindrical in shape and forms a top and a bottom opening, attaching an elastic band to the circumference of the fabric that forms said top opening and said bottom opening, said attaching resulting in a finished edge on said top opening and on said bottom opening thereby forming a one size fits many, form-fitting, removable, washable, reusable cover for an existing lampshade and covering said existing lampshade with said one size fits many, form-fitting, removable, washable, reusable cover

8. The method for covering an existing lampshade with a one size fits many, form-fitting, removable, washable, reusable cover according to claim 7 by providing a first band having a first color pattern or design printed on said band and a second band having a second color pattern or design printed on said band, said first band and said second band being identically sized and shaped and sandwiched together thereby providing a cover that has a first color, pattern or design printed on the first band that is the same or different from the second color, pattern or design printed on the second band.

9. The method for covering an existing lampshade with a one size fits many, form-fitting, removable, washable, reusable cover according to claim 8 wherein said cover is reversible

10. The method for covering an existing lampshade with a one size fits many, form-fitting, removable, washable, reusable cover according to claim 7 further comprising the step of creating a top and bottom opening which are the same or approximately the same in circumference by having a rectangular or substantially rectangular band of four way stretch fabric having a left edge and a right edge, distant from the left edge, and joining together said left and said right edge.

11. The method for covering an existing lampshade with a one size fits many, form-fitting, removable, washable, reusable cover according to claim 7 further comprising the step of creating a top opening having a circumference smaller than the circumference of the bottom opening by having an arch shaped band of four way stretch fabric having a left edge and a right edge, distant from the left edge, and joining together said left and said right edge.

12. The method for covering an existing lampshade with a one size fits many, form-fitting, removable, washable, reusable cover according to claim 7 wherein said cover extends beyond and over the top and bottom openings of the existing lampshade.

13. The method for covering an existing lampshade with a one size fits many, form-fitting, removable, washable, reusable cover according to claim 7 further comprising the step of having the at least one band of four way stretch fabric which is solid, textured, printed, embellished, monogrammed, or bears designs or logos.

14. The method for covering an existing lampshade with a one size fits many, form-fitting, removable, washable, reusable cover according to claim 7 wherein said cover camouflages wear and tear, blemishes, stains and general disrepair of the existing shade.
